(19) United States
(12) Patent Application Publication
(10) Pub. No.: US 2013/0223886 A1
(43) Pub. Date: Aug. 29, 2013

(54) CHARGING MEMBER, ELECTROPHOTOGRAPHIC PROCESS CARTRIDGE, AND ELECTROPHOTOGRAPHIC APPARATUS

(71) Applicant: CANON KABUSHIKI KAISHA, (US)

(72) Inventors: Noboru Miyagawa, Suntou-gun (JP); Hidekazu Matsuda, Susono-shi (JP); Satoshi Koide, Otsu-shi (JP)

(73) Assignee: CANON KABUSHIKI KAISHA, Tokyo (JP)

(21) Appl. No.: 13/860,361

(22) Filed: Apr. 10, 2013

Related U.S. Application Data
(63) Continuation of application No. PCT/JP2012/007660, filed on Nov. 29, 2012.

(30) Foreign Application Priority Data
Dec. 19, 2011 (JP) 2011-277618

(51) Int. Cl. G03G 15/02

(52) U.S. Cl. CPC G03G 13/025
USPC 399/176

(57) ABSTRACT

The present invention aims to achieve compatibility between high conductivity and durability against the application of a DC voltage in the charging member of an electrophotographic apparatus for maintaining the image quality of the electrophotographic apparatus in association with an increase in speed of the electrophotographic apparatus and more severe use conditions thereof in recent years. Provided is a charging member having a conductive support and a conductive elastic layer, in which: the elastic layer contains a polymer having an alkylene oxide chain in a molecule thereof, an ion conductive agent, and a polyrotaxane; and the polyrotaxane has a structure in which a linear molecule penetrates the inside of the ring of a cyclic molecule having an ionic group, the linear molecule has two block groups, and the block groups are placed at both terminals of the linear molecule to prevent the cyclic molecule from leaving the linear molecule.

### CROSS-REFERENCE TO RELATED APPLICATIONS

This application is a continuation of International Application No. PCT/JP2012/007660, filed on Nov. 29, 2012, which claims the benefit of Japanese Patent Application No. 2011-277618, filed on Dec. 19, 2011.

### BACKGROUND OF THE INVENTION

1. Field of the Invention

The present invention relates to a charging member to be used in an electrophotographic apparatus, and to an electrophotographic process cartridge and an electrophotographic apparatus each using the charging member.

2. Description of the Related Art

A charging member to be used for contact charging in an electrophotographic apparatus is generally provided with a conductive elastic layer for securing a nip with an electrophotographic photosensitive member. In addition, as described in Japanese Patent Application Laid-Open No. 2001-273815, an ion conductive agent such as a quaternary ammonium salt compound is sometimes used for making such elastic layer conductive. The ion conductive agent has such an advantage that a charging member showing small local unevenness of its electric resistance is obtained because the ion conductive agent is more easily dispersed in a binder resin in a uniform manner than an electronic conductive agent such as carbon black is.

On the other hand, when a DC voltage is continuously applied to a charging member having an elastic layer that has been made conductive with the ion conductive agent over a long time period, the electric resistance of the elastic layer may increase locally owing to the polarization of the ion conductive agent in the elastic layer. When the surface of a photosensitive member is charged with such charging member, charging unevenness occurs in the photosensitive member, which causes density unevenness in an electrophotographic image in some cases. Accordingly, the charging member having the elastic layer that has been made conductive with the ion conductive agent has been required to have the following characteristic. The electric resistance of the elastic layer hardly changes owing even to the long-term application of the DC voltage.

Besides, in recent years, an additionally high electron moving speed has been required to the conductive layer of a charging member. This is because the cycle of discharge from the charging member to a photosensitive member has started to shorten in association with a recent increase in process speed of an electrophotographic apparatus. That is, it is because an electron needs to be supplied to the surface of the charging member within an additionally short time period.

### SUMMARY OF THE INVENTION

In view of the foregoing, the present invention is directed to providing a charging member that hardly shows a local fluctuation in electric resistance owing even to long-term application of a DC voltage, and that can sufficiently correspond to an increase in process speed.

The present invention is also directed to providing an electrophotographic process cartridge and an electrophotographic apparatus capable of stably forming high-quality electrophotographic images.

According to one aspect of the present invention, there is provided a charging member having a conductive support and a conductive elastic layer, in which the elastic layer contains a polymer having an alkylene oxide chain in a molecule thereof, an ion conductive agent, and a polyrotaxane, the polyrotaxane has a linear molecule included in the manner of skewering in the opening of a cyclic molecule having an ionic group, the linear molecule has two block groups, and the block groups are placed on the linear polymer so as to prevent the cyclic molecule from leaving the linear molecule.

In addition, according to another aspect of the present invention, there is provided an electrophotographic process cartridge having a charging member and an electrophotographic photosensitive member, the cartridge being attachable to and detachable from the main body of an electrophotographic apparatus. Further, according to still another aspect of the present invention, there is provided an electrophotographic apparatus having the charging member and an electrophotographic photosensitive member placed so as to be chargeable by the charging member.

According to the present invention, the following charging member can be obtained. The polarization of an ion conductive agent is suppressed even after long-term application of a DC voltage, and as a result, a local fluctuation in electric resistance of the member hardly occurs and the member can sufficiently correspond to an increase in process speed. In addition, according to the present invention, an electrophotographic process cartridge and an electrophotographic apparatus capable of stably forming high-quality electrophotographic images can be obtained.

Further features of the present invention will become apparent from the following description of exemplary embodiments with reference to the attached drawings.

### BRIEF DESCRIPTION OF THE DRAWINGS

FIG. 1A is a schematic view illustrating a section of an example of a charging roller of the present invention.

FIG. 1B is a schematic view illustrating the side surface of the charging roller illustrated in FIG. 1A.

FIG. 2 is a schematic view of a polyrotaxane to be used in the present invention.

FIG. 3A is a schematic view illustrating the internal state of an elastic layer of the present invention upon application of a DC voltage to the elastic layer.

FIG. 3B is a schematic view illustrating the internal state of the elastic layer of the present invention when the DC voltage is continuously applied to the elastic layer.

FIG. 4A is a schematic view illustrating the internal state of the elastic layer of the present invention when the application of the DC voltage to the elastic layer is released.

FIG. 4B is a schematic view illustrating the internal state of the elastic layer of the present invention when the release of the application of the DC voltage to the elastic layer is continued.

FIG. 5 is a schematic view illustrating a state where a block group of the polyrotaxane to be used in the present invention is bonded to a binder polymer.

FIG. 6 is a schematic view illustrating an example of a measuring device for measuring the electric resistance value of a charging member according to the present invention.

FIG. 7 is a schematic view illustrating an example of an electrophotographic apparatus according to the present invention.

FIG. 8 is a schematic view illustrating an example of a process cartridge according to the present invention.

### DESCRIPTION OF THE EMBODIMENTS

Preferred embodiments of the present invention will now be described in detail in accordance with the accompanying drawings.

<Charging Member>

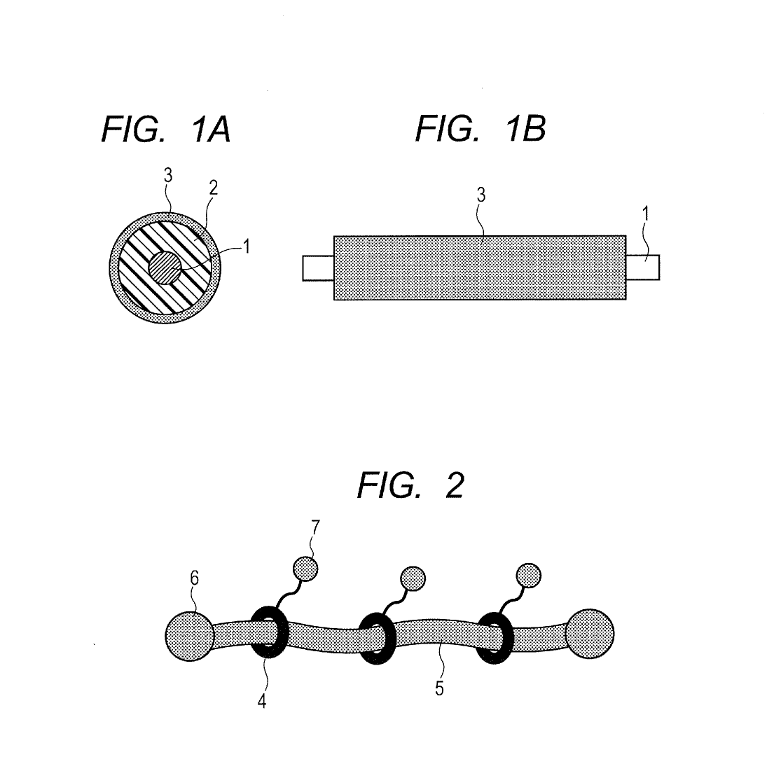

A charging member of the present invention can adopt various shapes such as a roller shape, a flat plate shape, and a belt shape. Hereinafter, the construction of the charging member of the present invention is described by taking a charging roller illustrated in FIG. 1A and FIG. 1B as an example. The charging roller has a conductive support 1 and an elastic layer 2 formed on the conductive support. The elastic layer 2 contains a polymer having an alkylene oxide chain in a molecule thereof, an ion conductive agent, and a polyrotaxane.

As illustrated in FIG. 2, the polyrotaxane is formed of a cyclic molecule 4, a linear molecule 5, and two block groups 6. The linear molecule 5 penetrates the inside of the ring of the cyclic molecule 4, and the block groups 6 are present at both terminals of the linear molecule 5. The cyclic molecule 4 has an ionic group 7. In addition, a structure in which the cyclic molecule 4 cannot leave the linear molecule 5 owing to the block groups 6 present at both terminals of the linear molecule 5 is established.

Adopting the construction suppresses an increase in resistance of the charging member due to the application of a DC voltage. As a result, the stability over time of the state of discharge between the charging member and a photosensitive member improves, and hence high-quality electrophotographic images can be stably formed. It is to be noted that the inventors of the present invention assume that the expression of the suppressing effect of the charging member according to the present invention on the increase of the resistance due to the application of the DC voltage is related to the movement and diffusion of the ion conductive agent at the time of the application of the DC voltage to the charging member and at the time of the release of the application of the DC voltage.

When a direct current is applied to a conventional charging member having an elastic layer that has been made conductive with an ion conductive agent, the current flows by virtue of the movement of an ion of the ion conductive agent. In addition, when a DC voltage is applied over a long time period, it gradually becomes difficult for the current to flow owing to the polarization of the ion conductive agent.

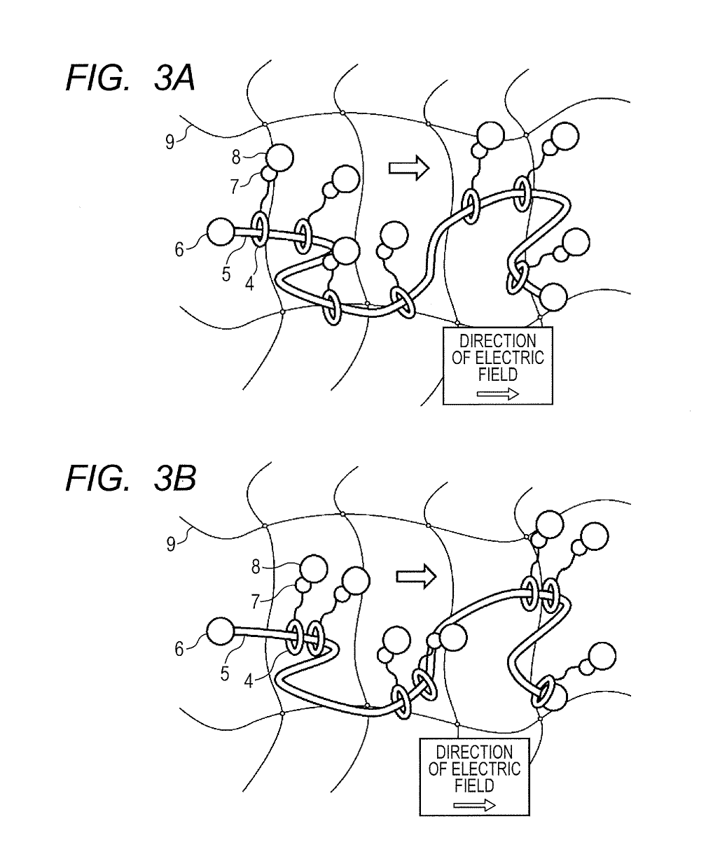

On the other hand, as illustrated in FIG. 3A, the polyrotaxane according to the present invention has a structure in which the linear molecule 5 penetrates the inside of the ring of the cyclic molecule 4 having the ionic group 7 and the cyclic molecule 4 cannot leave the linear molecule 5. Accordingly, an ion conductive agent 8 moves in the direction of a current in a state of being captured by the ionic group 7. However, the moving range of the ion conductive agent 8 is limited to the moving range of the cyclic molecule 4 specified by the length of the linear molecule 5. Accordingly, the polarization of the ion conductive agent 8 is suppressed even after long-term application of a DC voltage.

In addition, when the application of the DC voltage is continued, the cyclic molecules 4 move and finally agglomerate at a curved portion of the linear molecule 5 or the block group 6 as illustrated in FIG. 3B, whereby a state where the cyclic molecules 4 in the polyrotaxane are densely packed is established. That is, a nonuniform state of the cyclic molecules occurs.

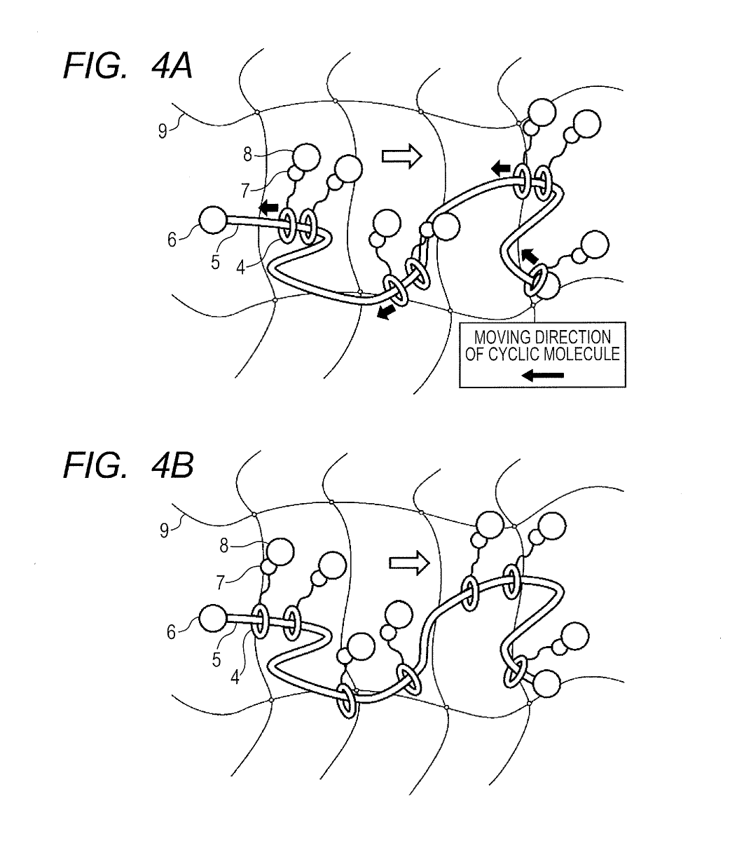

Next, when the application of the direct current is released in such a state as illustrated in FIG. 3B, the cyclic molecules 4 move in such a direction that the nonuniform state of the cyclic molecules is dissolved as illustrated in FIG. 4A. When the state continues, the cyclic molecules 4 further diffuse as illustrated in FIG. 4B, and in association with the diffusion, the captured ion conductive agents 8 also move and diffuse in the elastic layer.

As described above, in a state where the direct current is applied, the polarization of the ion conductive agent 8 is suppressed. On the other hand, in a state where the application of the direct current is released, the agglomerated cyclic molecules diffuse under the influence of the ion conductive agent 8 having high diffusibility. The foregoing is assumed to suppress an increase in resistance of the charging member with time due to the long-term application of the direct current.

The ion conductive agents 8 are unevenly distributed around the ionic groups 7. The ionic group 7 can be divided into an ion bonded to the cyclic molecule 4 and a counter ion present in a non-bonded state. For example, when the ionic group is a —COOH group, the group polarizes into a —COO⁻ ion and an H⁺ ion. Here, the —COO⁻ ion is the ion fixed to the cyclic molecule 4 and the counter ion is the H⁺ ion. In addition, when the ion conductive agent 8 is LiClO₄, the probability that an Li⁺ ion is present around the —COO⁻ ion fixed to the cyclic molecule 4 increases.

When the ionicity of the ionic group 7 is strong, the ion conductive agent 8 is seemingly subjected to ion exchange to be brought into a state of being bonded to the cyclic molecule 4. However, even if the ion conductive agent 8 is bonded to the cyclic molecule 4, conductivity is not inhibited because the cyclic molecule 4 can move along the linear molecule 5. Therefore, an electron moving speed may seldom reduce.

<Polyrotaxane>

The term “polyrotaxane” herein employed refers to the following molecule. A linear molecule penetrates the inside of the ring of a cyclic molecule, and block groups are placed at both terminals of a pseudo-polyrotaxane obtained through the inclusion of the linear molecule by the cyclic molecule (both terminals of the linear molecule) so as to prevent the cyclic molecule from being liberated. The term “inclusion” herein employed refers to a state where a linear molecule penetrates the inside of the ring of a cyclic molecule.

The cyclic molecule has an ionic group. The kind of the ionic group is not particularly limited as long as the ionic group has ionicity. An —OH group, a —COOM¹ group, an —SO₂M² group, an —NH₂ group, an —NH₃F group, an —NH₃Cl group, an —NH₃Br group, a —PO₄ group, and an —HPO₄ group can be given as examples of the ionic group. At least one kind selected from those ionic groups is desired.

It is to be noted that M¹ and M² each independently represent a hydrogen atom, lithium, sodium, or potassium. In addition, two or more kinds may be provided. In addition, at least one ionic group is desirably provided per one cyclic molecule.

Of the examples of the ionic group, an —OH group, a —COOM¹ group, and an —SO₂M² group are particularly preferred. This is because the groups each have a high suppressing effect on the increase of the resistance due to the application of the DC voltage.

In addition, when one and the same cyclic molecule is provided with both an ionic group having a high affinity for a cation (such as an —OH group, a —OOM¹ group, or an —SO₂M² group) and an ionic group having a high affinity for an anion (such as an —NH₂ group, an —NH₃F group, an —NH₃Cl group, or an —NH₃Br group), the increase of the resistance due to the application of the DC voltage can be additionally suppressed. A possible reason for the foregoing is that the polarization of both the cation and the anion is suppressed.

<Linear Molecule>

The linear molecule is not particularly limited as long as the molecule is a molecule or substance that is subjected to inclusion by the cyclic molecule and that can be integrated non-covalently, and the molecule is linear, and any molecule containing a polymer may be used. Here, the term “linear” of the linear molecule herein employed means that the molecule is substantially linear. That is, the linear molecule may have a branched chain as long as the cyclic molecule can rotate, or the cyclic molecule can slide or move along the linear molecule. In addition, the length of the straight chain is not particularly limited as long as the cyclic molecule can slide or move along the linear molecule.

In addition, the straight chain of the linear molecule is relatively determined in relation to a material for the polyrotaxane. That is, in the case of a material having a crosslinked structure in a part thereof, the linear molecule may occupy an extremely small part in the material. Even when the linear molecule occupies an extremely small part, its length is not particularly limited as long as the cyclic molecule can slide or move along the linear molecule as described above.

As the linear molecule, any of a hydrophilic polymer and a hydrophobic polymer can be used. Examples of the hydrophilic polymer may include a polyvinyl alcohol, a polyvinylpyrrolidone, a poly(meth)acrylic acid, cellulose-based resins (such as carboxymethylcellulose, hydroxyethylcellulose, and hydroxypropylcellulose), a polyacrylamide, a polyethylene oxide, a polyethylene glycol, a polyvinyl acetal-based resin, polyvinyl methyl ether, a polyamine, a polyethylene imine, casein, gelatin, starch, and a copolymer thereof.

Examples of the hydrophobic polymer may include: polyolefin-based resins such as a polyethylene, a polypropylene, and a copolymer resin containing any other olefin-based monomer; polyester resins; polyvinyl chloride resins; polystyrene-based resins such as a polystyrene and an acrylonitrile-styrene copolymer resin; acrylic resins such as a polymethyl methacrylate, a (meth)acrylic acid ester copolymer, and an acrylonitrile-methyl acrylate copolymer resin; polycarbonate resins; polyurethane resins; vinyl chloride-vinyl acetate copolymer resins; polyvinyl butyral resins; and a derivative thereof and a modified product thereof.

Additional examples of the hydrophobic polymer that can be used include: a polyisobutylene; a polytetrahydrofuran; a polyaniline; an acrylonitrile-butadien-styrene copolymer (ABS resin); polyamides such as nylon; polyimides; polydienes such as a polyisoprene and a polybutadiene; polysiloxanes such as a polydimethylsiloxane; polysulfones; polyimines; polyacetic anhydrides; polyureas; polysulfides; polyphosphazenes; polyketones; polyphenylenes; polyhaloolefins; and a derivative thereof.

Of those substances, the polyethylene glycol, the polyisoprene, the polyisobutylene, the polybutadiene, the polypropylene glycol, the polytetrahydrofuran, the polydimethylsiloxane, the polyethylene, and the polypropylene are preferred.

Of those, the polyethylene glycol, the polypropylene glycol, and the polybutadiene are particularly preferred. Each of those linear molecules can improve the mobility of the cyclic molecule because of its high molecular mobility. Accordingly, the increase of the resistance due to the application of the DC voltage is suppressed.

The weight-average molecular weight of the linear molecule is preferably 10³ or more, e.g., 10³ to 10⁶. The weight-average molecular weight is more preferably 10⁴ to 10⁵ from the viewpoints of the electron moving speed and the increase of the resistance due to the application of the DC voltage. As the molecular chain of the linear molecule lengthens, the moving ranges of the ion conductive agent and the cyclic molecule containing the ionic group widen. Accordingly, latitude for the reduction of the electron moving speed enlarges. In addition, as the molecular chain of the linear molecule shortens, the latitude for the reduction of the electron moving speed reduces, but the moving ranges of the ion conductive agent and the cyclic molecule containing the ionic group narrow, thereby improving the suppressing effect on the increase of the resistance due to the application of the DC voltage.

It is preferred that the linear molecule have reaction groups at both terminals thereof. The linear molecule can easily react with the block group because of having the reaction groups. Examples of the reaction group, which depends on a block group to be used, may include a hydroxyl group, an amino group, a carboxyl group, and a thiol group.

<Cyclic Molecule>

Examples of the cyclic molecule may include various cyclodextrin molecules including unmodified cyclodextrins such as α-cyclodextrin, β-cyclodextrin, and γ-cyclodextrin.

Each of those cyclodextrins can be a modified cyclodextrin each of these unmodified in which part or all of the hydroxy groups are modified. Examples thereof may include dimethylcyclodextrin, hydroxypropylcyclodextrin, hydroxyethylcyclodextrin, and acetylcyclodextrin.

The cyclodextrins differ from each other in size of the ring of a cyclodextrin molecule as a cyclic molecule depending on their kinds. Therefore, a cyclic molecule to be used can be selected depending on, for example, the kind of a linear molecule to be used, specifically, when the linear molecule to be used is regarded as being columnar, the diameter of a section of the column, and the hydrophobicity or hydrophilicity of the linear molecule. In addition, when a cyclic molecule having a relatively large ring and a columnar linear molecule having a relatively small diameter are used, two or more of such linear molecules can penetrate the inside of the ring of the cyclic molecule.

The other cyclic molecules include a crown ether, an azacrown ether, and a cyclic polyamine. In addition to those listed here, a substantially cyclic molecule (such as a C-shaped or U-shaped molecule) can be used.

Of those, α-cyclodextrin, β-cyclodextrin, and γ-cyclodextrin are particularly preferred. Those cyclic molecules each have high affinities for the ionic group and the ion conductive agent because the outside of each of their rings is hydrophilic. Accordingly, the abundance ratio of the ion conductive agent near the ionic group is increased. In addition, the cyclic molecules each have a high affinity for the linear molecule because the inside of each of their rings is hydrophobic. Accordingly, the diffusibility of each of the cyclic molecules improves. The increase of the resistance due to the application of the DC voltage is suppressed by the foregoing effects.

The ionic group can be provided by utilizing a functional group present on the cyclic molecule and by utilizing, for example, a chemical reaction. For example, a cyclodextrin holds a hydroxyl group on its ring. The ionic group can be bonded through, for example, a substitution reaction by utilizing the hydroxyl group. The same holds true for any other cyclic molecule.

One or more cyclic molecules are preferably provided per one linear molecule. Although an upper limit for the number of molecules is not particularly limited, the number preferably falls within such a range that the cyclic molecule can slide and move along the linear molecule. This is because the closest packing of the cyclic molecules in the linear molecule makes it difficult for the cyclic molecules to move.

It is not preferred that the cyclic molecule be bonded to any other cyclic molecule, the linear molecule, each of the block groups, and a material in the elastic layer. This is because of the following reason. The bonding of the cyclic molecule to the molecule, the group, or the material makes it difficult for the cyclic molecule to slide or move along the linear molecule, thereby making both the suppression of the increase of the resistance due to the application of the DC voltage and the maintenance of an electron conduction speed difficult.

<Block Groups>

The block groups are not particularly limited as long as the groups can hold a state where the linear molecule penetrates the inside of the ring of the cyclic molecule, and any group may be used.

For example, a group having bulkiness is desirably introduced as any such group. The term “group having bulkiness” herein employed refers to a group having a spatial expanse and capable of preventing the cyclic molecule from leaving the linear molecule among various groups including a molecular group and a polymer group. A group schematically represented in a spherical shape or a solid support represented like a side wall is permitted as long as the group or the support has such effect.

Examples of the block group may include: dinitrophenyl groups such as a 2,4-dinitrophenyl group and a 3,5-dinitrophenyl group; cyclodextrins; adamantane groups; trithyl groups; fluoresceins; pyrenes; and a derivative thereof and a modified product thereof. More specifically, even in the case where α-cyclodextrin is used as the cyclic molecule and a polyethylene glycol is used as the linear molecule, as the block group, there may be given, for example, cyclodextrins, dinitrophenyl groups such as a 2,4-dinitrophenyl group and a 3,5-dinitrophenyl group; adamantane groups; trithyl groups; fluoresceins; pyrenes; and a derivative thereof and a modified product thereof.

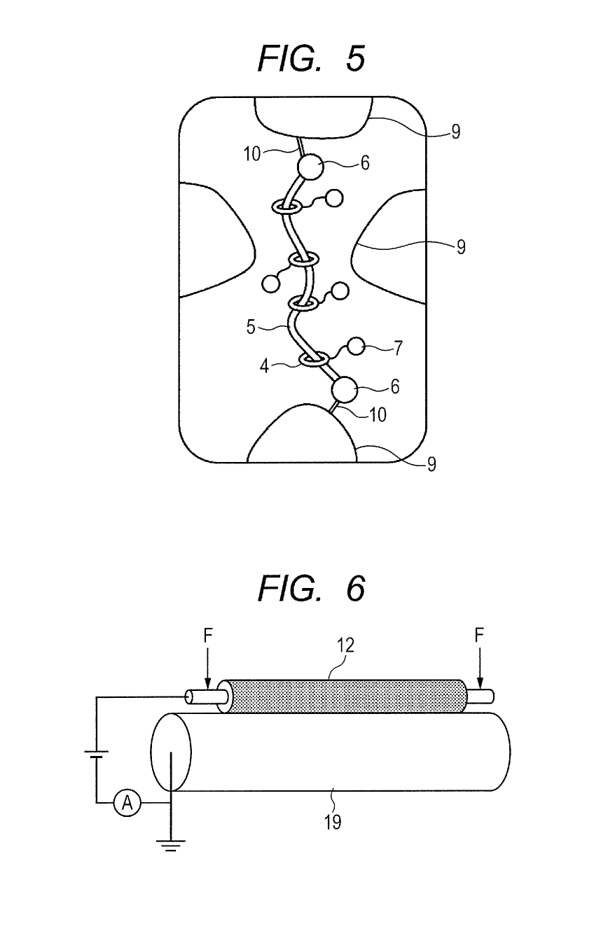

The block groups each desirably have a carbon-carbon double bond. Accordingly, the block groups can each be subjected to a crosslinking reaction with the polymer in the elastic layer to fix the linear molecule. As illustrated in FIG. 5, the formation of a crosslinked structure 10 between the block group 6 of the polyrotaxane and a polymer 9 in the elastic layer enables the cyclic molecule to slide and move while immobilizing the polyrotaxane. Accordingly, the suppressing effect on the increase of the resistance due to the application of the DC voltage can be additionally improved.

<Method of Producing Polyrotaxane>

A method of producing the polyrotaxane involves dissolving the cyclic molecule and the linear molecule in a reaction solvent, and stirring the solution. At that time, heating reflux may be performed. Accordingly, a pseudo-rotaxane in which the linear molecule penetrates the inside of the ring of the cyclic molecule is produced. The term “pseudo-rotaxane” herein employed refers to a molecule of a rotaxane structure in which both terminals of the linear molecule are not sealed with the block groups. In this state, the cyclic group leaves the linear molecule. The introduction of the block groups needs to be quickly performed before the leaving occurs.

The introduction of the block groups is performed by the chemical bonding of a functional group at each of both terminals of the linear molecule and the functional group of each of the block groups. At this time, reaction design needs to be performed so as to prevent each of the block groups from reacting with the cyclic molecule. For example, in the case of a rotaxane of a polyethylene glycol and a cyclodextrin, a terminal hydroxyl group of the polyethylene glycol and a hydroxyl group of the cyclodextrin overlap, and hence the block groups each react with the cyclodextrin. In such case, a pretreatment for changing the terminal hydroxyl group of the ethylene glycol into an amine or a pretreatment for changing the group into a carboxylic acid group can be performed.

A method involving subjecting all hydroxyl groups of the cyclodextrin to an alkoxylation treatment is also conceivable. However, the ionic group needs to be introduced into the cyclodextrin and a hydroxyl group is needed for the introduction. Accordingly, the following method is desirably adopted. The cyclic molecule and the linear molecule both terminals of which have been pretreated are dissolved in the reaction solvent, and then the solution is stirred to produce the pseudo-rotaxane. After that, the block groups are introduced to introduce the ionic group into the cyclic molecule.

<Polymer Having Alkylene Oxide Chain in Molecule Thereof>

The term “polymer having an alkylene oxide chain in a molecule thereof” herein employed refers to a polymer having a chain of alkylene oxide such as ethylene oxide, or propylene oxide in a molecule thereof. Specific examples thereof include an epichlorohydrin-ethylene oxide copolymer, an epichlorohydrin-ethylene oxide-allyl glycidyl ether copolymer, an ethylene oxide-propylene oxide copolymer, and an ethylene oxide-propylene oxide-allyl glycidyl ether copolymer. The epichlohydrin-ethylene oxide-allyl glycidyl ether copolymer and the ethylene oxide-propylene oxide-allyl glycidyl ether copolymer are particularly preferred. Those polymers can be subjected to sulfur vulcanization, and can be easily imparted with rubber elasticity.

With regard to each of the ethylene oxide chain and the propylene oxide chain, the content of the alkylene oxide chain in the molecule is preferably 24 mol % or more and 80 mol % or less with respect to 100 mol % of the polymer. In addition, with regard to the allyl glycidyl ether chain, the content is preferably 1 mol % or more and 15 mol % or less with respect to 100 mol % of the polymer.

<Any Other Polymer>

As long as the polymer having the alkylene oxide chain in a molecule thereof is used as a main component, an acrylonitrile-butadiene rubber, an acrylic rubber, a urethane rubber, an ethylene-propylene rubber, a styrene-butadiene rubber, a silicone rubber, an acrylic rubber, or the like can be used as an accessory component in the elastic layer. The content of the accessory component is desirably 40 parts by mass or less with respect to 100 parts by mass of the main component.

<Ion Conductive Agent>

The following agents can each be used as the ion conductive agent: an inorganic ionic substance such as lithium perchlorate, a cationic surfactant such as a modified aliphatic dimethylethyl ammonium ethosulfate, a zwitterionic surfactant such as a dimethyl alkyl lauryl betaine, a quaternary ammonium salt such as trimethyloctadecyl ammonium perchlorate, and an organic acid lithium salt such as lithium trifluoromethanesulfonate.

One kind of those substances can be used alone, or two or more kinds thereof can be used in combination.

Of the ion conductive agents, a quaternary ammonium perchlorate is particularly suitably used because its resistance is stable against an environmental change. The amount of the ion conductive agent in the elastic layer suitably falls within the range of 0.01 part by mass or more and 5 parts by mass or less, preferably 0.1 part by mass or more and 2 parts by mass or less with respect to 100 parts by mass of the polymer component.

<Conductive Support>

The conductive support has conductivity and has a function of supporting a layer such as the surface layer to be provided on the support. As a material for the support, there may be given metals such as iron, copper, stainless steel, aluminum, and nickel, and alloys thereof.

<Formation of Elastic Layer>

The elastic layer contains, as essential components, the polymer having the alkylene oxide chain in a molecule thereof, the ion conductive agent, and the polyrotaxane. In addition to the components, a plasticizer, an extender, a vulcanizing agent, a vulcanization accelerator, an age resister, a foaming agent, or the like can be arbitrarily used.

The polymer having the alkylene oxide chain in a molecule thereof, the ion conductive agent, the polyrotaxane, any one of the other various additives, and the like are kneaded with a kneading machine to produce a raw material rubber composition as a material for forming the elastic layer. Examples of the kneading machine include a ribbon blender, a Nauta mixer, a Henschel mixer, a super mixer, a Banbury mixer, and a pressure kneader.

The following method is given as an example of a method of forming the elastic layer from the raw material rubber composition.

The conductive support to which an adhesive has been applied is defined as a central axis, the top of the axis is coated with the raw material rubber composition in a cylindrical manner, and the conductive support and the elastic layer material are integrally extruded with an extrusion molding device provided with a crosshead to produce the elastic layer.

The crosshead is a device generally used in the coating of an electric wire or a wire, and is used by being attached to the rubber-discharging portion of the cylinder of the extruder.

A method involving forming a rubber tube and inserting the conductive support to which an adhesive has been applied into the tube to bond the support is also given. A method involving coating the conductive support to which an adhesive has been applied with an unvulcanized rubber sheet and vulcanizing the resultant in a die is also given.

<Polishing>

In addition, the surface of the resultant charging member may be polished. An NC cylindrical polishing machine of a traverse system, an NC cylindrical polishing machine of a plunge cut system, or the like can be used as a cylindrical polishing machine for forming a predetermined outer diameter dimension. The NC cylindrical polishing machine of the plunge cut system is preferred because of the following reasons. The machine uses a wider grinding wheel than that of the traverse system and hence can shorten a processing time. In addition, a change in diameter of the grinding wheel is small.

<Surface Layer>

A surface layer may be formed by subjecting the top of the elastic layer to coating and heating. The surface layer is formed through coating with the coating liquid of a raw material. A coating method is, for example, a vertical ring coating method, a dipping coating method (immersion coating method), a spray coating method, a roll coating method, a curtain coating method, or gravure printing. Of those, the vertical ring coating method or the dipping coating method is preferred. The thickness of the surface layer is preferably about 1 μm or more and 100 μm or less. The thickness is more preferably about 10 μm or more and 30 μm or less.

<Physical Property Values and Methods of Measuring the Values>

The electric resistance, surface roughness, and hardness of the charging member of the present invention, which are not particularly limited, preferably fall within the following ranges. The electric resistance is measured with such a measuring device as illustrated in FIG. 6. The electric resistance is preferably 10⁴Ω or more and 10⁷Ω or less in a method involving bringing the member into abutment with an aluminum drum 19 and applying a voltage of 200 V to measure the electric resistance. With regard to the surface roughness, the member preferably has a ten-point average roughness Rz measured with a contact-type surface roughness meter of 0.1 μm or more and 50 μm or less. The member preferably has a hardness measured with an Asker C hardness meter of 20° or more and 80° or less.

<Electrophotographic Apparatus>

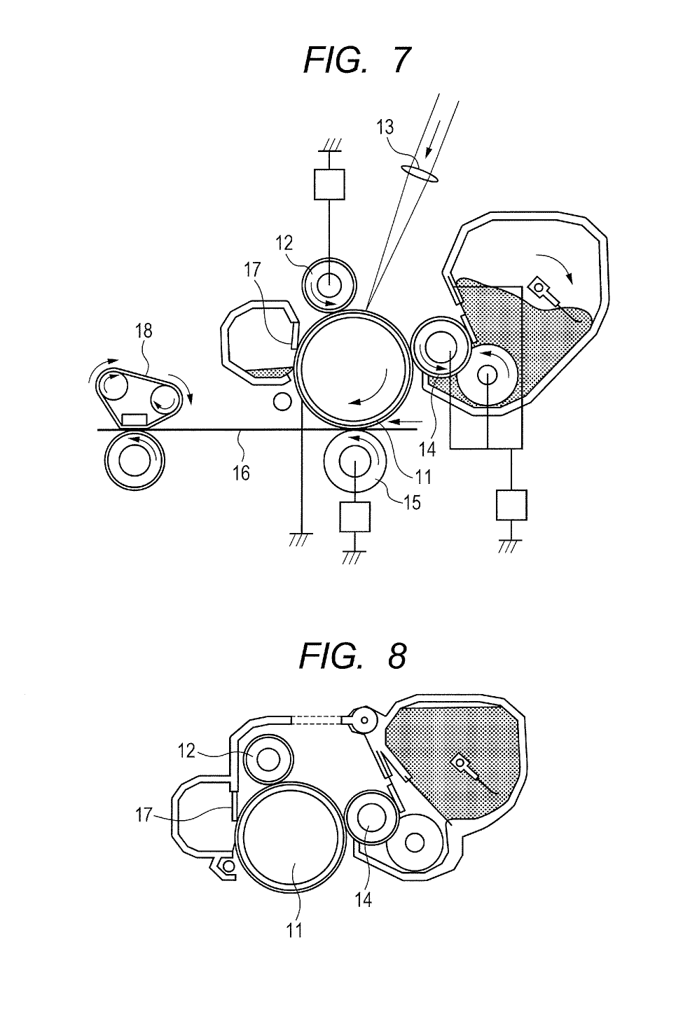

FIG. 7 illustrates a schematic view of an example of an electrophotographic apparatus.

A drum-shaped electrophotographic photosensitive member (hereinafter referred to as “photosensitive member”) 11 has a photosensitive layer on a conductive substrate. In addition, the photosensitive member 11 is rotationally driven in a direction indicated by an arrow at a predetermined peripheral speed (process speed).

A charging device has a charging roller 12. The photosensitive member 11 is placed so as to be chargeable by the charging roller. Here, the charging roller 12 is pressed against the photosensitive member 11 at a predetermined pressing force to be brought into contact therewith, and the charging roller 12 submissively rotates according to the rotation of the photosensitive member 11. Then, a predetermined DC voltage is applied from a power source for charging to the charging roller, whereby the photosensitive member is charged to a predetermined potential. An exposing device such as a laser beam scanner is used as a latent image-forming device (not shown) for forming an electrostatic latent image on the photosensitive member 11. The electrostatic latent image is formed by irradiating the uniformly charged photosensitive member with exposure light 13 corresponding to image information.

A developing device has a developing roller 14 placed to be close to, or in contact with, the photosensitive member. In the case of reversal development, the electrostatic latent image is visualized and developed into a toner image with toner subjected to an electrostatic treatment to have the same polarity as the charged polarity of the photosensitive member. A transferring device has a contact-type transfer roller 15. The device transfers the toner image from the photosensitive member 11 onto a transfer material 16 such as plain paper (the transfer material is conveyed by a sheet-feeding system having a conveying member).

A cleaning device has a blade-type cleaning member 17 and a recovery container, and mechanically scrapes off and recovers transfer residual toner remaining on the photosensitive member after the transfer. Here, the cleaning device can be omitted by adopting a simultaneous development cleaning system involving recovering the transfer residual toner in the developing device. A fixing device 18 is formed of, for example, a heated roll, and fixes the transferred toner image onto the transfer material 16 and discharges the resultant to the outside of the device.

<Process Cartridge>

A process cartridge (FIG. 8) obtained by integrating, for example, a photosensitive member, a charging device, a developing device, and a cleaning device, and designed to be detachable from an electrophotographic apparatus can also be used. That is, the process cartridge has a charging member integrated with at least a body to be charged and is attachable to and detachable from the main body of the electrophotographic apparatus, and the charging member is the charging member according to the present invention. In addition, the electrophotographic apparatus has at least a process cartridge, an exposing device, and a fixing device, and the process cartridge is the process cartridge according to the present invention.

### EXAMPLE

Hereinafter, the present invention is described in more detail by way of specific examples. However, the technical scope of the present invention is not limited to these examples.

### Production Example A-1

### Production of Polyrotaxane 1

25.0 Grams of α-cyclodextrin (CD) were weighed and dissolved in pure water. 1.72 Grams of a polyethylene glycol bisamine (PEG-BA: weight-average molecular weight: 10,000) were added to the solution, and then the mixture was heated and stirred at a temperature of 80° C. The aqueous solution after the reaction was added to acetone to cause precipitation. The produced precipitate was separated by filtration. The precipitate was vacuum-dried at room temperature to provide 23 g of an inclusion material of the polyethylene glycol bisamine and α-cyclodextrin.

20 Grams of the inclusion material, 7.2 g of 2,4-dinitrofluorobenzene, and 100 ml of N,N-dimethylformamide were mixed, and then the mixture was heated and stirred under a nitrogen atmosphere at a temperature of 60° C. The resultant solution was added to acetone to cause precipitation. The produced precipitate was separated by filtration. The precipitate separated by filtration was further dissolved in dimethyl sulfoxide. Reprecipitation was performed in water and then the precipitate was separated by filtration. The precipitate separated by filtration was vacuum-dried. Thus, a polyrotaxane 1 (4.2 g) was obtained.

### Production Example A-2

### Production of Polyrotaxane 2

The polyrotaxane 1 (1 g) was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 0.8 g of monochloroacetic acid in 20 ml of DMSO was dropped to the stirred product, and then the mixture was heated and stirred at a temperature of 40° C. After that, 300 ml of pure water were added to the mixture and then the whole was neutralized with 5N hydrochloric acid. The resultant was reprecipitated with acetone and then freeze-dried. Thus, a polyrotaxane 2 (1 g) in which a part of the hydroxyl groups of α-cyclodextrin were substituted with —CH₂COOH groups was obtained.

### Production Example A-3

### Production of Polyrotaxane 3

A polyrotaxane 3 (0.96 g) in which a part of the hydroxyl groups of α-cyclodextrin were substituted with CH₂CH₂SO₃Na groups was obtained by the same method as that of Production Example A-2 with the exception that 0.8 g of monochloroacetic acid was changed to 1.8 g of sodium bromoethanesulfonate.

### Production Example A-4

### Production of Polyrotaxane 4

A polyrotaxane 4 (0.90 g) in which a part of the hydroxyl groups of α-cyclodextrin were substituted with CH₂CH₂NH₂ groups was obtained by the same method as that of Production Example A-2 with the exception that 3 g of monochloroacetic acid was changed to 0.8 g of bromoethylammonium bromide.

### Production Example A-5

### Production of Polyrotaxane 5

30.0 Grams of β-cyclodextrin (CD) were weighed and dissolved in pure water. 3 Grams of a polypropylene glycol both terminals of which are carboxylated (PPG-BC: weight-average molecular weight: 5,000) were added to the solution, and then the mixture was heated and stirred at a temperature of 50° C. The aqueous solution after the reaction was added to acetone to cause precipitation. The produced precipitate was separated by filtration. The precipitate was vacuum-dried at room temperature to provide 26 g of an inclusion material of the polypropylene glycol both terminals of which are carboxylated and β-cyclodextrin.

25 Grams of the inclusion material, 5.2 g of adamantaneamine, 3 g of a benzotriazole-1-yl-oxy-tris-(dimethylamino) phosphonium hexafluorophosphate (BOP) reagent, and 1 g of 1-hydroxybenzotriazole (HOBt) were added to 50 ml of dimethylformamide (DMF), and then the mixture was stirred at room temperature under a nitrogen atmosphere. The resultant solution was added to a mixed solution of DMF and methanol to cause precipitation. The produced precipitate was separated by filtration. The product separated by filtration was further dissolved in dimethyl sulfoxide. The solution was added to water to cause reprecipitation and then the precipitate was separated by filtration. The precipitate separated by filtration was vacuum-dried. Thus, a polyrotaxane 5 (5.3 g) was obtained.

### Production Example A-6

### Production of Polyrotaxane 6

The polyrotaxane 5 (1 g) was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 1.0 g of monochloroacetic acid in 20 ml of DMSO was dropped to the stirred product, and then the mixture was heated and stirred at a temperature of 40° C. After that, 300 ml of pure water were added to the mixture and then the whole was neutralized with 5N hydrochloric acid. The resultant was reprecipitated with acetone and then freeze-dried. Thus, a polyrotaxane 6 (1 g) in which a part of the hydroxyl groups of β-cyclodextrin were substituted with —CH₂COOH groups was obtained.

### Production Example A-7

### Production of Polyrotaxane 7

A polyrotaxane 7 (0.96 g) in which a part of the hydroxyl groups of β-cyclodextrin were substituted with —CH₂CH₂SO₃Na groups was obtained by the same method as that of Production Example A-6 with the exception that 1.0 g of monochloroacetic acid was changed to 1.8 g of sodium bromoethanesulfonate.

### Production Example A-8

### Production of Polyrotaxane 8

A polyrotaxane 8 (0.90 g) in which a part of the hydroxyl groups of β-cyclodextrin were substituted with —CH₂CH₂NH₂ groups was obtained by the same method as that of Production Example A-6 with the exception that 1.0 g of monochloroacetic acid was changed to 3 g of bromoethylammonium bromide.

### Production Example A-9

### Production of Polyrotaxane 9

50.0 Grams of γ-cyclodextrin (CD) were weighed and dissolved in pure water. 5 Grams of a polyethylene glycol both terminals of which are aminated (PEG-BA: weight-average molecular weight: 2,000) were added to the solution, and then the mixture was heated and stirred at a temperature of 50° C. The aqueous solution after the reaction was added to acetone to cause precipitation. The produced precipitate was separated by filtration. The precipitate was vacuum-dried at room temperature to provide 46 g of an inclusion material of the polypropylene glycol both terminals of which are animated and γ-cyclodextrin.

25 Grams of the inclusion material, 5.0 g of 5-norbornene-2-carboxylic acid, 3 g of a benzotriazole-1-yl-oxy-tris-(dimethylamino)phosphonium hexafluorophosphate (BOP) reagent, and 1 g of 1-hydroxybenzotriazole (HOBt) were added to 50 ml of dimethylformamide (DMF), and then the mixture was stirred at room temperature under a nitrogen atmosphere. The resultant solution was added to a mixed solution of DMF and methanol to cause precipitation. The produced precipitate was separated by filtration. The product separated by filtration was further dissolved in dimethyl sulfoxide. The solution was added to water to cause reprecipitation and then the precipitate was separated by filtration. The precipitate separated by filtration was vacuum-dried. Thus, a polyrotaxane 9 (5.3 g) was obtained.

### Production Example A-10

### Production of Polyrotaxane 10

The polyrotaxane 9 (1 g) was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 1.0 g of monochloroacetic acid in 20 ml of DMSO was dropped to the mixture, and then the mixture was heated and stirred at a temperature of 40° C. After that, 300 ml of pure water were added to the mixture and then the whole was neutralized with 5N hydrochloric acid. The resultant mixture was reprecipitated with acetone and then freeze-dried. Thus, a polyrotaxane 10 (1 g) in which a part of the hydroxyl groups of γ-cyclodextrin were substituted with —CH₂COOH groups was obtained.

### Production Example A-11

### Production of Polyrotaxane 11

A polyrotaxane 11 (0.96 g) in which a part of the hydroxyl groups of γ-cyclodextrin were substituted with —CH₂CH₂SO₃Na groups was obtained by the same method as that of Production Example A-10 with the exception that 1.0 g of monochloroacetic acid was changed to 1.8 g of bromoethylammonium bromide.

### Production Example A-12

### Production of Polyrotaxane 12

A polyrotaxane 12 (0.90 g) in which a part of the hydroxyl groups of γ-cyclodextrin were substituted with —CH₂CH₂NH₂ groups was obtained by the same method as that of Production Example A-10 with the exception that 1.0 g of monochloroacetic acid was changed to 3 g of bromoethylammonium bromide.

### Production Example A-13

### Production of Polyrotaxane 13

50.0 Grams of γ-cyclodextrin (CD) were weighed and dissolved in pure water. 6 Grams of a polyethylene polybutadiene both terminals of which are carboxylated (PBD-BC: weight-average molecular weight: 3,000) were added to the solution, and then the mixture was heated and stirred at a temperature of 50° C. The aqueous solution after the reaction was added to acetone to cause precipitation. The produced precipitate was separated by filtration. The precipitate was vacuum-dried at room temperature to provide 43 g of an inclusion material of the polybutadiene both terminals of which are carboxylated and γ-cyclodextrin.

27 Grams of the inclusion material, 4.8 g of adamantaneamide, 3 g of a benzotriazole-1-yl-oxy-tris-(dimethylamino) phosphonium hexafluorophosphate (BOP) reagent, and 1 g of 1-hydroxybenzotriazole (HOBt) were added to 50 ml of dimethylformamide (DMF), and then the mixture was stirred at room temperature under a nitrogen atmosphere. The resultant solution was added to a mixed solution of DMF and methanol to cause precipitation. The produced precipitate was separated by filtration. The product separated by filtration was further dissolved in dimethyl sulfoxide. The solution was added to water to cause reprecipitation and then the precipitate was separated by filtration. The precipitate separated by filtration was vacuum-dried. Thus, a polyrotaxane (12 g) in which both terminals of the polybutadiene are sealed was obtained.

Next, the polyrotaxane (10 g) in which both terminals of the polybutadiene are sealed was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 1.8 g of sodium bromoethanesulfonate in 20 ml of DMSO was dropped to the stirred product, and then the mixture was heated and stirred at a temperature of 40° C. After that, 300 ml of pure water were added to the mixture and then the whole was neutralized with 5N hydrochloric acid. The resultant mixture was reprecipitated with acetone and then freeze-dried. Thus, a polyrotaxane 13 (3.4 g) in which a part of the hydroxyl groups of γ-cyclodextrin were substituted with CH₂CH₂SO₃Na groups was obtained.

### Production Example A-14

### Production of Polyrotaxane 14

3.4 Grams of 2-hydroxyethyl-18-crown-6-ether and 0.6 g of N,N′-bis(3-aminopropyl)-1,4-butanediamine were dissolved in 50 ml of N,N-dimethylformamide, and then the solution was stirred for 1 hour under a nitrogen atmosphere at a temperature of 70° C. After that, 7.2 g of 2,4-dinitrofluorobenzene were added to the solution, and then the mixture was further heated and stirred at a temperature of 70° C. The solvent was removed under reduced pressure and then the remainder was purified by preparative liquid chromatography. Thus, a polyrotaxane 14 (1.3 g) of a crown ether having a hydroxy group and a polyamine was obtained.

### Production Example A-15

### Production of Polyrotaxane 15

The polyrotaxane 14 (1 g) was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 1.0 g of monochloroacetic acid in 20 ml of DMSO was dropped to the mixture, and then the mixture was heated and stirred at a temperature of 40° C. After that, 300 ml of pure water were added to the mixture and then the whole was neutralized with 5N hydrochloric acid. The resultant mixture was reprecipitated with acetone and then freeze-dried. Thus, a polyrotaxane 15 (1 g) in which the hydroxyl groups of a crown either were substituted with —CH₂COOH groups was obtained.

### Production Example A-16

### Production of Polyrotaxane 16

A polyrotaxane 16 (0.96 g) in which the hydroxyl groups of a crown either were substituted with —CH₂CH₂SO₃Na groups was obtained by the same method as that of Production Example A-15 with the exception that 1.0 g of monochloroacetic acid was changed to 1.8 g of sodium bromoethanesulfonate.

### Production Example A-17

### Production of Polyrotaxane 17

A polyrotaxane 17 (0.90 g) in which the hydroxyl groups of a crown either were substituted with —CH₂CH₂NH₂ groups was obtained by the same method as that of Production Example A-15 with the exception that 1.0 g of monochloroacetic acid was changed to 3 g of bromoethylammonium bromide.

### Production Example A-18

### Production of Polyrotaxane 18

3.4 Grams of 2-hydroxyethyl-15-crown-5-ether and 0.6 g of diethylenetetramine were dissolved in 50 ml of N,N-dimethylformamide, and then the solution was stirred for 1 hour under a nitrogen atmosphere at a temperature of 70° C. After that, 7.2 g of 2,4-dinitrofluorobenzene were added to the solution, and then the mixture was further heated and stirred at a temperature of 70° C. The solvent was removed under reduced pressure and then the remainder was purified by preparative liquid chromatography. Thus, a polyrotaxane 18 (1.5 g) of a crown ether having a hydroxy group and a polyamine was obtained.

### Production Example A-19

### Production of Polyrotaxane 19

The polyrotaxane 18 (1 g) was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 1.0 g of monochloroacetic acid in 20 ml of DMSO was dropped to the stirred product, and then the mixture was heated and stirred at a temperature of 40° C. After that, 300 ml of pure water were added to the mixture and then the whole was neutralized with 5N hydrochloric acid. The resultant mixture was reprecipitated with acetone and then freeze-dried. Thus, a polyrotaxane 19 (1 g) in which the hydroxyl groups of a crown either were substituted with —CH₂COOH groups was obtained.

### Production Example A-20

### Production of Polyrotaxane 20

A polyrotaxane 20 (0.96 g) in which the hydroxyl groups of a crown either were substituted with —CH₂CH₂SO₃Na groups was obtained by the same method as that of Production Example A-19 with the exception that 1.0 g of monochloroacetic acid was changed to 1.8 g of sodium bromoethanesulfonate.

### Production Example A-21

### Production of Polyrotaxane 21

A polyrotaxane 21 (0.90 g) in which the hydroxyl groups of a crown ether were substituted with —CH₂CH₂NH₂ groups was obtained by the same method as that of Production Example A-19 with the exception that 1.0 g of monochloroacetic acid was changed to 3 g of bromoethylammonium bromide. The polyrotaxane 1 to the polyrotaxane 21 were subjected to structural analyses by NMR, IR, GPC, and ESI-MS. Table 1 shows the results.

TABLE 1
Polyrotaxane

| | | Ionic | | |
|---|---|---|---|---|
| No. | Cyclic molecule | group | Linear molecule | Block group |
| 1 | α-Cyclodextrin | OH | Polyethylene glycol both terminals of which | 2,4-Dinitrofluorobenzene |
| | | | are aminated (molecular weight: 10,000) | |
| 2 | α-Cyclodextrin | COOH, OH | Polyethylene glycol both terminals of which | 2,4-Dinitrofluorobenzene |
| | | | are aminated (molecular weight: 10,000) | |
| 3 | α-Cyclodextrin | So₃Na, OH | Polyethylene glycol both terminals of which | 2,4-Dinitrofluorobenzene |
| | | | are aminated (molecular weight: 10,000) | |
| 4 | α-Cyclodextrin | NH₂, OH | Polyethylene glycol both terminals of which | 2,4-Dinitrofluorobenzene |
| | | | are aminated (molecular weight: 10,000) | |
| 5 | β-Cyclodextrin | OH | Polypropylene glycol both terminals of which | Adamantaneamine |
| | | | are carboxylated (molecular weight: 5,000) | |
| 6 | β-Cyclodextrin | COOH, OH | Polypropylene glycol both terminals of which | Adamantaneamine |
| | | | are carboxylated (molecular weight: 5,000) | |
| 7 | β-Cyclodextrin | SO₃Na, OH | Polypropylene glycol both terminals of which | Adamantaneamine |
| | | | are carboxylated (molecular weight: 5,000) | |
| 8 | β-Cyclodextrin | NH₂, OH | Polypropylene glycol both terminals of which | Adamantaneamine |
| | | | are carboxylated (molecular weight: 5,000) | |
| 9 | γ-Cyclodextrin | OH | Polyethylene glycol both terminals of which | 5-Norbornene-2-carboxylic acid |
| | | | are aminated (molecular weight: 20,000) | |
| 10 | γ-Cyclodextrin | COOH, OH | Polyethylene glycol both terminals of which | 5-Norbornene-2-carboxylic acid |
| | | | are aminated (molecular weight: 20,000) | |
| 11 | γ-Cyclodextrin | SO₃Na, OH | Polyethylene glycol both terminals of which | 5-Norbornene-2-carboxylic acid |
| | | | are aminated (molecular weight: 20,000) | |
| 12 | γ-Cyclodextrin | NH₂, OH | Polyethylene glycol both terminals of which | 5-Norbornene-2-carboxylic acid |
| | | | are aminated (molecular weight: 20,000) | |
| 13 | γ-Cyclodextrin | SO₃Na, OH | Polybutadiene both terminals of which | Adamantaneamine |
| | | | are carboxylated (molecular weight: 3,000) | |
| 14 | 2-Hydroxyethyl-18- | OH | N,N′-Bis(3-aminopropyl)-1,4-butanediamine | 2,4-Dinitrofluorobenzene |
| | crown-6-ether | | | |
| 15 | 2-Hydroxyethyl-18- | COOH | N,N′-Bis(3-aminopropyl)-1,4-butanediamine | 2,4-Dinitrofluorobenzene |
| | crown-6-ether | | | |
| 16 | 2-Hydroxyethyl-18- | SO₃Na | N,N′-Bis(3-aminopropyl)-1,4-butanediamine | 2,4-Dinitrofluorobenzene |
| | crown-6-ether | | | |
| 17 | 2-Hydroxyethyl-18- | NH₂ | N,N′-Bis(3-aminopropyl)-1,4-butanediamine | 2,4-Dinitrofluorobenzene |
| | crown-6-ether | | | |
| 18 | 2-Hydroxyethyl-15- | OH | Diethylenetriamine | 2,4-Dinitrofluorobenzene |
| | crown-5-ether | | | |
| 19 | 2-Hydroxyethyl-15- | COOH | Diethylenetriamine | 2,4-Dinitrofluorobenzene |
| | crown-5-ether | | | |
| 20 | 2-Hydroxyethyl-15- | SO₃Na | Diethylenetriamine | 2,4-Dinitrofluorobenzene |
| | crown-5-ether | | | |
| 21 | 2-Hydroxyethyl-15- | NH₂ | Diethylenetriamine | 2,4-Dinitrofluorobenzene |
| | crown-5-ether | | | |

### Production Example A-22

### Production of Polyrotaxane 22

The polyrotaxane 1 (1 g) was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 0.8 g of 1-chloropropane in 20 ml of DMSO was dropped to the mixture, and then the mixture was heated and stirred at a temperature of 40° C. for 48 hours. After that, 300 ml of pure water were added to the mixture and then the whole was neutralized with 5N hydrochloric acid. The resultant mixture was reprecipitated with acetone and then freeze-dried. Thus, a polyrotaxane 22 (1 g) in which all hydroxyl groups of α-cyclodextrin were substituted with —CH₂CH₂CH₃ groups was obtained.

### Production Example A-23

### Production of Polyrotaxane 23

The polyrotaxane 5 (1 g) was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 1.0 g of 1-chloropropane in 20 ml of DMSO was dropped to the stirred product, and then the mixture was heated and stirred at a temperature of 40° C. for 48 hours. After that, 300 ml of pure water were added to the mixture and then the whole was neutralized with 5N hydrochloric acid. The resultant mixture was reprecipitated with acetone and then freeze-dried. Thus, a polyrotaxane 23 (1 g) in which all hydroxyl groups of β-cyclodextrin were substituted with —CH₂CH₂CH₃ groups was obtained.

### Production Example A-24

### Production of Polyrotaxane 24

The polyrotaxane 9 (1 g) was dissolved in 80 ml of dimethyl sulfoxide (DMSO). After that, an aqueous solution of sodium hydroxide was gradually added to the solution and then the mixture was stirred under a nitrogen atmosphere. A solution prepared by dissolving 1.0 g of 1-chloropropane in 20 ml of DMSO was dropped to the mixture, and then the mixture was heated and stirred at a temperature of 40° C. for 48 hours. After that, 300 ml of pure water were added to the mixture and then the whole was neutralized with 5N hydrochloric acid. The resultant mixture was reprecipitated with acetone and then freeze-dried. Thus, a polyrotaxane 24 (1 g) in which all hydroxyl groups of γ-cyclodextrin were substituted with —CH₂CH₂CH₃ groups was obtained.

### Production Example A-25

### Production of Polyrotaxane 25

3.4 Grams of 18-crown-6-ether and 0.6 g of N,N′-bis(3-aminopropyl)-1,4-butanediamine were dissolved in 50 ml of N,N-dimethylformamide, and then the solution was stirred for 1 hour under a nitrogen atmosphere at a temperature of 70° C. After that, 7.2 g of 2,4-dinitrofluorobenzene were added to the solution, and then the mixture was further heated and stirred at a temperature of 70° C. The solvent was removed under reduced pressure and then the remainder was purified by preparative liquid chromatography. Thus, a polyrotaxane 25 (1.3 g) of a crown ether having a hydroxy group and a polyamine was obtained.

### Production Example A-26

### Production of Polyrotaxane 26

3.4 Grams of 15-crown-5-ether and 0.6 g of N,N′-bis(3-aminopropyl)-1,4-butanediamine were dissolved in 50 ml of N,N-dimethylformamide, and then the solution was stirred for 1 hour under a nitrogen atmosphere at a temperature of 70° C. After that, 7.2 g of 2,4-dinitrofluorobenzene were added to the solution, and then the mixture was further heated and stirred at a temperature of 70° C. The solvent was removed under reduced pressure and then the remainder was purified by preparative liquid chromatography. Thus, a polyrotaxane 26 (1.5 g) of a crown ether having a hydroxy group and a polyamine was obtained.

The polyrotaxane 22 to the polyrotaxane 26 were subjected to structural analyses by NMR, IR, GPC, and ESI-MS. Table 2 shows the results.

TABLE 2
Polyrotaxane

| | | Ionic | | |
|---|---|---|---|---|
| No. | Cyclic molecule | group | Linear molecule | Block group |
| 22 | α-Cyclodextrin | None | Polyethylene glycol | 2,4-Dinitrofluorobenzene |
| | (all hydroxyl | | both terminals of which | |
| | groups are | | are aminated (molecular | |
| | propoxylated) | | weight: 10,000) | |
| 23 | β-Cyclodextrin | None | Polypropylene glycol | Adamantaneamine |
| | (all hydroxyl | | both terminals of which | |
| | groups are | | are carboxylated | |
| | propoxylated) | | (molecular weight: 5,000) | |
| 24 | γ-Cyclodextrin | None | Polyethylene glycol | 5-Norbornene-2- |
| | (all hydroxyl | | both terminals of which | carboxylic acid |
| | groups are | | are aminated (molecular | |
| | propoxylated) | | weight: 20,000) | |
| 25 | 18-Crown-6- | None | N,N′-Bis(3-aminopropyl)- | 2,4-Dinitrofluorobenzene |
| | ether | | 1,4-butanediamine | |
| 26 | 15-Crown-5- | OH | Diethylenetriamine | 2,4- |
| | ether | | | Dinitrofluorobenzene |

### Production Example B-1

### Production of Fine Particles 1

140 Grams of a methyl hydrogen polysiloxane were added to 7.0 kg of silica particles (average particle diameter: 15 nm; volume resistivity: 1.8×10¹² Ω·cm) while an edge runner was operated, and then the contents were mixed and stirred under a linear load of 588 N/cm (60 kg/cm) for 30 minutes. A stirring speed at this time was 22 rpm. 7.0 Kilograms of carbon black “#52” (trade name; manufactured by Mitsubishi Chemical Corporation) were added to the mixture over 10 minutes while the edge runner was operated, and then the contents were mixed and stirred under a linear load of 588 N/cm (60 kg/cm) for an additional sixty minutes. Thus, the carbon black was caused to adhere to the surfaces of the silica particles coated with the methyl hydrogen polysiloxane. After that, the resultant was dried with a dryer at a temperature of 80° C. for 60 minutes. Thus, fine particles 1 were obtained. A stirring speed at this time was 22 rpm. It is to be noted that the resultant fine particles 1 had an average particle diameter of 15 nm and a volume resistivity of 1.1×10² Ω·cm.

### Production Example B-2

### Production of Fine Particles 2

110 Grams of isobutyltrimethoxysilane as a surface treatment agent and 3,000 g of toluene as a solvent were blended into 1,000 g of needle-shaped, rutile-type titanium oxide particles (average particle diameter: 15 nm; longitudinal:horizontal=3:1; volume resistivity: 2.3×10¹⁰ Ω·cm) to prepare a slurry. The contents of the slurry were mixed with a stirring machine for 30 minutes, and then the slurry was supplied to a visco mill 80% of the effective internal volume of which was filled with glass beads having an average particle diameter of 0.8 mm to be subjected to a wet shredding treatment at a temperature of 35±5° C. Toluene was removed from the slurry obtained by the wet shredding treatment with a kneader by distillation under reduced pressure (bath temperature: 110° C.; product temperature: 30 to 60° C.; degree of decompression: about 100 Torr), and then a treatment for baking the surface treatment agent was performed at a temperature of 120° C. for 2 hours. The particles subjected to the baking treatment were cooled to room temperature and then pulverized with a pin mill. Thus, fine particles 2 were produced.

### Example 1

### Production of Charging Roller 1

A thermosetting adhesive (trade name: METALOC U-20; manufactured by TOYOKAGAKU KENKYUSHO CO., LTD.) was applied to a rod made of stainless steel having a diameter of 6 mm and a length of 252 mm, and then the resultant was left at rest in a hot-air oven at a temperature of 200° C. for 30 minutes to provide a conductive support.

In the production of a compound for an elastic layer, first, materials shown in Table 3 were kneaded with a closed mixer whose temperature had been regulated to 50° C. for 15 minutes to prepare a rubber compound A.

TABLE 3

| | | |
|---|---|---|
| Epichlorohydrin-ethylene oxide-allyl | 100 | parts by mass |
| glycidyl ether terpolymer as a polymer | | |
| having an alkylene oxide chain in a molecule | | |
| thereof (EP:EO:AGE = 37 mol %:55 mol %:7.5 | | |
| mol %) | | |
| Tetrabutylammonium perchlorate as an ion | 3 | parts by mass |
| conductive agent | | |
| Polyrotaxane 1 | 5 | parts by mass |
| Zinc stearate | 1 | part by mass |
| Zinc oxide | 5 | parts by mass |
| Calcium carbonate | 50 | parts by mass |
| Adipic acid-based polyester | 10 | parts by mass |

Next, materials shown in Table 4 were kneaded with a twin-roll mill cooled to a temperature of 20° C. for 15 minutes to prepare a rubber compound B.

TABLE 4

| | | |
|---|---|---|
| Rubber compound A | 175 | parts by mass |
| Sulfur | 1.2 | parts by mass |
| Di-2-benzothiazolyldisulfide (MBTS) | 1 | part by mass |
| Tetramethylthiuram monosulfide (TMTM) | 1 | part by mass |

Subsequently, the conductive support as a central axis was coated with the rubber compound B in a cylindrical manner with a crosshead extruder, and then the resultant was heated and vulcanized in a hot-air oven at a temperature of 160° C. to provide an elastic layer roller precursor having an outer diameter of 9 mm. The temperature of the crosshead extruder was set to 80° C. The end portions of the elastic layer of the resultant elastic layer roller precursor were cut off and then the remainder was polished with a cylindrical polishing machine of a plunge cut system. Thus, an elastic layer roller in which the outer diameter of the elastic layer was adjusted to φ8.5 mm was obtained. The state of the polyrotaxane 1 in the elastic layer was identified by NMR, IR, GPC, and ESI-MS. The identification confirmed that the structure of a rotaxane was maintained.

Next, methyl isobutyl ketone was added to a caprolactone-modified acrylic polyol solution “PLACCEL DC2016” (trade name; manufactured by Daicel Chemical Industries, Ltd.) to adjust the solid content to 10 mass %. Components shown in Table 5 were added to 1,000 parts by mass of the solution (100 parts by mass of the acrylic polyol solid content) to prepare a mixed solution.

TABLE 5

| | | |
|---|---|---|
| Fine particles 1 (produced in | 45 | parts by mass |
| Production Example B-1) | | |
| Fine particles 2 (produced in | 20 | parts by mass |
| Production Example B-2) | | |
| Acrylic particles: “MBX-8” | 5 | parts by mass |
| (trade name, manufactured by | | |
| Techno Polymer Co., Ltd.) | | |
| Modified dimethyl silicone | 0.08 | part by mass |
| oil (*1) | | |
| Block isocyanate mixture (*2) | 80.14 | parts by mass |

(*1) Modified dimethyl silicone oil “SH28PA” (trade name; manufactured by Tore Dow Corning Silicone Co., Ltd.)
(*2) A mixture of butanone oxime block products, i.e., a mixture of hexamethylene diisocyanate (HDI) and isophorone diisocyanate (IPDI) at a ratio of 7:3

At this time, the amount of the block isocyanate mixture was in an amount given by “NCO/OH=1.0” in terms of the isocyanate amount.

(*1) Modified dimethyl silicone oil “SH28PA” (trade name; manufactured by Tore Dow Corning Silicone Co., Ltd.)
(*2) A mixture of butanone oxime block products, i.e., a mixture of hexamethylene diisocyanate (HDI) and isophorone diisocyanate (IPDI) at a ratio of 7:3

200 Grams of the mixed solution were loaded into a glass bottle having an internal volume of 450 mL together with 200 g of glass beads having an average particle diameter of 0.8 mm as media, and then the contents were dispersed with a paint shaker dispersing machine for 24 hours, followed by the removal of the glass beads. Thus, a conductive resin application liquid was produced.

The produced elastic layer roller was subjected to dipping coating with the conductive resin application liquid once. The resultant was air-dried at normal temperature for 30 minutes, and was then dried with a hot air-circulating dryer at a temperature of 80° C. for 1 hour and at a temperature of 160° C. for 1 hour. Thus, a charging roller 1 was obtained. Here, conditions for the dipping coating are as described below. An immersion time was 9 seconds, an initial dipping coating pulling speed was 20 mm/s, a final dipping coating pulling speed was 2 mm/s, and the dipping coating was performed while a speed was linearly changed with time between the speeds.

—Evaluation of Charging Roller 1—

<Evaluation for Streak-Like Image>

A color laser printer (trade name: Satera LBP5400; manufactured by Canon Inc.) was prepared as an electrophotographic apparatus. It is to be noted that the color laser printer can output A4 size paper in a longitudinal direction. In addition, upon its use in an evaluation, the color laser printer was reconstructed so as to output a recording medium at a speed of 200 mm/sec.

The charging roller 1 was mounted on a process cartridge for the color laser printer and then the process cartridge was mounted on the color laser printer.

Electrophotographic images were continuously formed with the color laser printer in a low-temperature, low-humidity environment (temperature: 15° C.; humidity: 10% RH). It is to be noted that the resolution of each of the images is 600 dpi and the output of primary charging is a DC voltage of −1,100 V.

The electrophotographic image formation was performed by repeating the following pattern. A predetermined number of images in each of which an alphabetical letter “E” having a size of 4 points was printed on A4 size paper so as to have an image density of 2% (hereinafter referred to as “E-letter images”) were continuously output, and then one halftone image for an evaluation was output. It is to be noted that the “halftone image” herein employed refers to such an image that horizontal lines each having a width of 1 dot are drawn in a direction perpendicular to the rotation direction of a photosensitive member at an interval of 2 dots.

Halftone images were formed at the following five timings: before the formation of an E-letter image, after the output of 1,000 E-letter images, after the output of 4,000 E-letter images, after the output of 8,000 E-letter images, and after the output of 10,000 E-letter images. Thus, a total of five halftone images were obtained. Then, the presence or absence of the occurrence of a streak resulting from the electric resistance unevenness of the charging roller, and the degree of the streak were visually observed for each of all halftone images, and were then evaluated based on the criteria of Table 6 below.

TABLE 6

| | |
|---|---|
| Rank 1 | No streaks are observed in all halftone images. |
| Rank 2 | A slight streak is observed in the halftone |
| | image output after the output of 10,000 E-letter |
| | images. |
| Rank 3 | Streaks are observed in all halftone images. |

<Evaluation for Degree of Increase in Resistance Due to Application of DC Voltage>

The electric resistance values of the charging roller at an initial stage (0k) and after the output of the 10,000 images (abbreviated as “10k”) in the low-temperature, low-humidity environment (temperature: 15° C.; humidity: 10% RH) were measured. The measurement method for each electric resistance value was performed with the device illustrated in FIG. 6. The charging roller was brought into contact with the aluminum drum, and then a load F of 500 g was applied to each of both ends of the conductive support (i.e., a total of 1,000 g at both ends) so that a contact area became uniform. The aluminum drum was rotated, and then a DC voltage of 200 V was applied to the charging roller while the roller was submissively rotated, followed by the measurement of a current flowing through the roller. The electric resistance value (unit: kΩ) of the charging roller was determined from the measured value.

### Examples 2 to 21

### Production of Charging Roller 2 to Charging Roller 21

Charging rollers 2 to 21 were each obtained by the same method as that of the charging roller 1 with the exception that the kinds and blending amounts of the polymer having an alkylene oxide chain in a molecule thereof, the ion conductive agent, and the polyrotaxane were changed as shown in Table 7 or Table 8. Those charging rollers were evaluated in the same manner as in Example 1.

TABLE 7

| | Polymer having alkylene | | | | | |
|---|---|---|---|---|---|---|
| | oxide chain in | | | | | |
| | molecule thereof | | Ion conductive agent | | Polyrotaxane | |
| | | Addition | | Addition | | Addition |
| Charging | | amount | | amount | | amount |
| roller | | (part(s) | | (part(s) | | (part(s) |
| No. | Substance name | by mass) | Substance name | by mass) | Polyrotaxane No. | by mass) |
| 1 | Epichlorohydrin-ethylene oxide- | 100 | Tetrabutylammonium | 3 | Polyrotaxane 1 | 5 |
| | allyl glycidyl ether copolymer | | perchlorate | | | |
| | (EP:EO:AGE = 37:55:7.5) | | | | | |
| 2 | Epichlorohydrin-ethylene oxide- | 100 | Tetrabutylammonium | 2 | Polyrotaxane 2 | 3 |
| | allyl glycidyl ether copolymer | | perchlorate | | | |
| | (EP:EO:AGE = 37:55:7.5) | | | | | |
| 3 | Epichlorohydrin-ethylene oxide- | 100 | Tetrabutylammonium | 3.2 | Polyrotaxane 3 | 4 |
| | allyl glycidyl ether copolymer | | perchlorate | | | |
| | (EP:EO:AGE = 37:55:7.5) | | | | | |
| 4 | Epichlorohydrin-ethylene oxide- | 100 | Tetrabutylammonium | 1.8 | Polyrotaxane 4 | 6 |
| | allyl glycidyl ether copolymer | | perchlorate | | | |
| | (EP:EO:AGE = 37:55:7.5) | | | | | |
| 5 | Ethylene oxide-propylene oxide- | 100 | Lithium perchlorate | 1 | Polyrotaxane 5 | 8 |
| | allyl glycidyl ether copolymer | | | | | |
| | (EO:PO:AGE = 30:62:7.5) | | | | | |
| 6 | Ethylene oxide-propylene oxide- | 100 | Lithium perchlorate | 2 | Polyrotaxane 6 | 7 |
| | allyl glycidyl ether copolymer | | | | | |
| | (EO:PO:AGE = 30:62:7.5) | | | | | |
| 7 | Ethylene oxide-propylene oxide- | 100 | Lithium perchlorate | 3 | Polyrotaxane 7 | 6 |
| | allyl glycidyl ether copolymer | | | | | |
| | (EO:PO:AGE = 30:62:7.5) | | | | | |
| 8 | Ethylene oxide-propylene oxide- | 100 | Lithium perchlorate | 1.5 | Polyrotaxane 8 | 4 |
| | allyl glycidyl ether copolymer | | | | | |
| | (EO:PO:AGE = 30:62:7.5) | | | | | |
| 9 | Epichlorohydrin-ethylene oxide- | 100 | Dimethyl-hydroxyethyl- | 1.5 | Polyrotaxane 9 | 5.5 |
| | allyl glycidyl ether copolymer | | octylammonium perchlorate | | | |
| | (EP:EO:AGE = 57:35:7.5) | | | | | |
| 10 | Epichlorohydrin-ethylene oxide- | 100 | Dimethyl-hydroxyethyl- | 2.5 | Polyrotaxane 10 | 6.5 |
| | allyl glycidyl ether copolymer | | octylammonium | | | |
| | (EP:EO:AGE = 57:35:7.5) | | perchlorate | | | |
| 11 | Epichlorohydrin-ethylene oxide- | 100 | Dimethyl-hydroxyethyl- | 1.2 | Polyrotaxane 11 | 8.5 |
| | allyl glycidyl ether copolymer | | octylammonium perchlorate | | | |
| | (EP:EO:AGE = 57:35:7.5) | | | | | |
| 12 | Epichlorohydrin-ethylene oxide- | 100 | Dimethyl-hydroxyethyl- | 1.8 | Polyrotaxane 12 | 8.5 |
| | allyl glycidyl ether copolymer | | octylammonium perchlorate | | | |
| | (EP:EO:AGE = 57:35:7.5) | | | | | |
| 13 | Epichlorohydrin-ethylene oxide- | 100 | Dimethyl-hydroxyethyl- | 2.1 | Polyrotaxane 13 | 4.5 |
| | allyl glycidyl ether copolymer | | octylammonium perchlorate | | | |
| | (EP:EO:AGE = 37:55:7.5) | | | | | |
| 14 | Ethylene oxide-propylene oxide- | 100 | Tetrabutylammonium | 3 | Polyrotaxane 14 | 9 |
| | allyl glycidyl ether copolymer | | perchlorate | | | |
| | (EO:PO:AGE = 50:42:7.5) | | | | | |
| 15 | Ethylene oxide-propylene oxide- | 100 | Tetrabutylammonium | 3 | Polyrotaxane 15 | 3 |
| | allyl glycidyl ether copolymer | | perchlorate | | | |
| | (EO:PO:AGE = 50:42:7.5) | | | | | |
| 16 | Ethylene oxide-propylene oxide- | 100 | Tetrabutylammonium | 3 | Polyrotaxane 16 | 2 |
| | allyl glycidyl ether copolymer | | perchlorate | | | |
| | (EO:PO:AGE = 50:42:7.5) | | | | | |

TABLE 8

| | Polymer having alkylene | | | | | |
|---|---|---|---|---|---|---|
| | oxide chain in | | | | | |
| | molecule thereof | | Ion conductive agent | | Polyrotaxane | |
| | | Addition | | Addition | | Addition |
| Charging | | amount | | amount | | amount |
| roller | | (part(s) | | (part(s) | | (part(s) |
| No. | Substance name | by mass) | Substance name | by mass) | Polyrotaxane No. | by mass) |
| 17 | Ethylene oxide-propylene oxide- | 100 | Tetrabutylammonium | 3 | Polyrotaxane 17 | 6 |
| | allyl glycidyl ether copolymer | | perchlorate | | | |
| | (EO:PO:AGE = 50:42:7.5) | | | | | |
| 18 | Epichlorohydrin-ethylene oxide- | 100 | Dimethyl-hydroxyethyl- | 1.2 | Polyrotaxane 18 | 5.2 |
| | allyl glycidyl ether copolymer | | octylammonium perchlorate | | | |
| | (EP:EO:AGE = 37:55:7.5) | | | | | |
| 19 | Epichlorohydrin-ethylene oxide- | 100 | Dimethyl-hydroxyethyl- | 3 | Polyrotaxane 19 | 6.2 |
| | allyl glycidyl ether copolymer | | octylammonium perchlorate | | | |
| | (EP:EO:AGE = 37:55:7.5) | | | | | |
| 20 | Epichlorohydrin-ethylene oxide- | 100 | Dimethyl-hydroxyethyl- | 2.9 | Polyrotaxane 20 | 7.2 |
| | allyl glycidyl ether copolymer | | octylammonium perchlorate | | | |
| | (EP:EO:AGE = 37:55:7.5) | | | | | |
| 21 | Epichlorohydrin-ethylene oxide- | 100 | Dimethyl-hydroxyethyl- | 1 | Polyrotaxane 21 | 1.5 |
| | allyl glycidyl ether copolymer | | octylammonium perchlorate | | | |
| | (EP:EO:AGE = 37:55:7.5) | | | | | |

### Comparative Examples 1 to 5

### Production of Charging Roller 22 to Charging Roller 26

Charging rollers 22 to 26 were each obtained by the same method as that of the charging roller 1 with the exception that the kinds and blending amounts of the polymer having an alkylene oxide chain in a molecule thereof, the ion conductive agent, and the polyrotaxane were changed as shown in Table 9. Those charging rollers were evaluated in the same manner as in Example 1.

TABLE 9

| | Polymer having alkylene oxide | | | | | |
|---|---|---|---|---|---|---|
| | chain in molecule thereof | | Ion conductive agent | | Polyrotaxane | |
| | | Addition | | Addition | | Addition |
| Charging | | amount | | amount | | amount |
| roller | | (part(s) | | (part(s) | | (part(s) |
| No. | Substance name | by mass) | Substance name | by mass) | Polyrotaxane No. | by mass) |
| 22 | Epichlorohydrin-ethylene oxide- | 100 | Lithium perchlorate | 0.8 | Polyrotaxane 22 | 0.5 |
| | allyl glycidyl ether copolymer | | | | | |
| | (EP:EO:AGE = 57:35:7.5) | | | | | |
| 23 | Epichlorohydrin-ethylene oxide- | 100 | Tetrabutylammonium | 1.2 | Polyrotaxane 23 | 1.2 |
| | allyl glycidyl ether copolymer | | perchlorate | | | |
| | (EP:EO:AGE = 57:35:7.5) | | | | | |
| 24 | Ethylene oxide-propylene oxide- | 100 | Tetrabutylammonium | 1 | Polyrotaxane 24 | 2 |
| | allyl glycidyl ether copolymer | | perchlorate | | | |
| | (EO:PO:AGE = 50:42:7.5) | | | | | |
| 25 | Epichlorohydrin-ethylene oxide- | 100 | Tetrabutylammonium | 0.8 | Polyrotaxane 25 | 2.2 |
| | allyl glycidyl ether copolymer | | perchlorate | | | |
| | (EP:EO:AGE = 37:55:7.5) | | | | | |
| 26 | Epichlorohydrin-ethylene oxide- | 100 | Lithium perchlorate | 0.5 | Polyrotaxane 26 | 2.8 |
| | allyl glycidyl ether copolymer | | | | | |
| | (EP:EO:AGE = 57:35:7.5) | | | | | |

### Comparative Example 6

### Production of Charging Roller 27

A charging roller 27 was obtained by the same method as that of the charging roller 1 with the exception that 5 parts by mass of the polyrotaxane 1 were changed to a mixture of respective raw materials shown in Table 10. The charging roller was evaluated in the same manner as in Example 1.

TABLE 10

| | |
|---|---|
| α-Cyclodextrin | 1 part by mass |
| Polyethylene glycol both | 1 part by mass |
| terminals of which are | |
| aminated (weight-average | |
| molecular weight: 10,000) | |
| 2,4-Dinitrofluorobenzene | 0.05 part by mass |

### Comparative Example 7

### Production of Charging Roller 28

A charging roller 28 was obtained by the same method as that of the charging roller 27 with the exception that the formulation of the charging roller 27 was changed as shown in Table 11. The charging roller was evaluated in the same manner as in Example 1.

TABLE 11

| Charging roller 27 | Charging roller 28 |
|---|---|
| α-Cyclodextrin 1 part by | β-Cyclodextrin 1 part by |
| mass | mass |
| Polyethylene glycol both | Polypropylene glycol both |
| terminals of which are | terminals of which are |
| aminated (weight-average | carboxylated (weight- |
| molecular weight: 10,000) | average molecular weight: |
| 1 part by mass | 5,000) |
| | 1 part by mass |
| 2,4-Dinitrofluorobenzene | Adamantaneamine |
| 0.05 part by mass | 0.05 part by mass |
| Tetrabutylammonium | Lithium perchlorate |
| perchlorate | 3 parts by mass |
| 3 parts by mass | |

### Comparative Example 8

### Production of Charging Roller 29

A charging roller 29 was obtained by the same method as that of the charging roller 27 with the exception that the formulation of the charging roller 27 was changed as shown in Table 12. The charging roller was evaluated in the same manner as in Example 1.

TABLE 12

| Charging roller 27 | Charging roller 29 |
|---|---|
| Epichlorohydrin-ethylene | Epichlorohydrin-ethylene |
| oxide-allyl glycidyl ether | oxide-allyl glycidyl ether |
| terpolymer (EP:EO:AGE = | copolymer (EP:EO:AGE = |
| 37 mol %:55 mol %:7.5 mol %) | 57 mol %:35 mol %:7.5 mol %) |
| 100 part by mass | 100 parts by mass |
| α-Cyclodextrin | γ-Cyclodextrin |
| 1 part by mass | 1 part by mass |
| Polyethylene glycol both | Polybutadiene both terminals |
| terminals of which are | of which are carboxylated |
| aminated (weight-average | (weight-average molecular |
| molecular weight: 10,000) | weight: 3,000) |
| 1 part by mass | 1 part by mass |
| 2,4-Dinitrofluorobenzene | Adamantaneamine |
| 0.05 part by mass | 0.05 part by mass |

Table 13 shows the evaluation results of Examples 1 to 21 and Table 14 shows the evaluation results of Comparative Examples 1 to 8.

TABLE 13

| | Charging | Initial | After | | | | | |
|---|---|---|---|---|---|---|---|---|
| | roller | stage | 10k | Streak image | | | | |
| Example | No. | kΩ | kΩ | 0k | 1k | 4k | 8k | 10k |
| 1 | 1 | 81 | 83 | 1 | 1 | 1 | 1 | 1 |
| 2 | 2 | 86 | 89 | 1 | 1 | 1 | 1 | 1 |
| 3 | 3 | 65 | 68 | 1 | 1 | 1 | 1 | 1 |
| 4 | 4 | 87 | 97 | 1 | 1 | 1 | 1 | 1 |
| 5 | 5 | 75 | 77 | 1 | 1 | 1 | 1 | 2 |
| 6 | 6 | 63 | 66 | 1 | 1 | 1 | 1 | 1 |
| 7 | 7 | 80 | 82 | 1 | 1 | 1 | 1 | 1 |
| 8 | 8 | 85 | 98 | 1 | 1 | 1 | 1 | 2 |
| 9 | 9 | 51 | 53 | 1 | 1 | 1 | 1 | 1 |
| 10 | 10 | 57 | 59 | 1 | 1 | 1 | 1 | 1 |
| 11 | 11 | 71 | 75 | 1 | 1 | 1 | 1 | 1 |
| 12 | 12 | 77 | 92 | 1 | 1 | 1 | 1 | 2 |
| 13 | 13 | 70 | 72 | 1 | 1 | 1 | 1 | 1 |
| 14 | 14 | 64 | 102 | 1 | 1 | 1 | 2 | 2 |
| 15 | 15 | 63 | 105 | 1 | 1 | 1 | 2 | 2 |
| 16 | 16 | 63 | 101 | 1 | 1 | 1 | 2 | 2 |
| 17 | 17 | 65 | 105 | 1 | 1 | 1 | 2 | 2 |
| 18 | 18 | 59 | 148 | 1 | 1 | 2 | 2 | 2 |
| 19 | 19 | 78 | 154 | 1 | 1 | 2 | 2 | 2 |
| 20 | 20 | 67 | 150 | 1 | 1 | 2 | 2 | 2 |
| 21 | 21 | 65 | 137 | 1 | 1 | 2 | 2 | 2 |

TABLE 14

| | Charging | Initial | After | | | | | |
|---|---|---|---|---|---|---|---|---|
| Comparative | roller | stage | 10k | Streak image | | | | |
| Example | No. | kΩ | kΩ | 0k | 1k | 4k | 8k | 10k |
| 1 | 22 | 65 | 189 | 1 | 1 | 2 | 2 | 3 |
| 2 | 23 | 74 | 198 | 1 | 1 | 2 | 2 | 3 |
| 3 | 24 | 59 | 189 | 1 | 1 | 2 | 2 | 3 |
| 4 | 25 | 57 | 232 | 1 | 2 | 2 | 2 | 3 |
| 5 | 26 | 53 | 225 | 1 | 2 | 2 | 2 | 3 |
| 6 | 27 | 57 | 305 | 1 | 2 | 2 | 3 | 3 |
| 7 | 28 | 71 | 315 | 1 | 2 | 2 | 3 | 3 |
| 8 | 29 | 74 | 296 | 1 | 2 | 2 | 3 | 3 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-277618 filed on Dec. 19, 2011, which is hereby incorporated by reference herein in its entirety.

What is claimed is:

1. A charging member, comprising:
a conductive support; and
a conductive elastic layer,
wherein:
the elastic layer comprises a polymer having an alkylene oxide chain in a molecule thereof, an ion conductive agent, and a polyrotaxane; and
the polyrotaxane has a structure in which
a linear molecule penetrates an inside of a ring of a cyclic molecule having an ionic group,
the linear molecule has two block groups, and
the block groups are placed at both terminals of the linear molecule to prevent the cyclic molecule from leaving the linear molecule.

2. The charging member according to claim 1, wherein the ionic group comprises at least one kind selected from the group consisting of an —OH group, a —COOM⁻ group, and an —SO₃M² group where M¹ and M² each independently represent hydrogen, lithium, sodium, or potassium.

3. The charging member according to claim 1, wherein the cyclic molecule comprises at least one cyclodextrin molecule selected from the group consisting of α-cyclodextrin, β-cyclodextrin, and γ-cyclodextrin.

4. The charging member according to claim 1, wherein the linear molecule comprises at least one selected from the group consisting of a polyethylene glycol, a polypropylene glycol, and a polybutadiene.

5. A process cartridge, comprising:
the charging member according to claim 1; and
an electrophotographic photosensitive member placed so as to be chargeable by the charging member,
wherein the process cartridge is attachable to and detachable from a main body of an electrophotographic apparatus.

6. An electrophotographic apparatus, comprising:
the charging member according to claim 1;
an electrophotographic photosensitive member placed so as to be chargeable by the charging member;
an exposing device; and
a fixing device.
